(19) United States
(12) Patent Application Publication
(10) Pub. No.: US 2010/0085316 A1
(43) Pub. Date: Apr. 8, 2010

(54) MOBILE TERMINAL AND DISPLAY CONTROLLING METHOD THEREIN

(76) Inventor: Jong Hwan Kim, Suwon-Si (KR)

Correspondence Address: BIRCH STEWART KOLASCH & BIRCH, PO BOX 747, FALLS CHURCH, VA, 22040-0747, US

(21) Appl. No.: 12/483,643

(22) Filed: Jun. 12, 2009

(30) Foreign Application Priority Data
Oct. 7, 2008 (KR) 10-2008-0098223

(51) Int. Cl. G06F 3/041; G06F 3/033

(52) U.S. Cl. 345/173; 715/863

(57) ABSTRACT

A mobile terminal including a touchscreen display unit configured to display at least a first image and to receive touch inputs, a projector module configured to project the first image displayed on the touchscreen display unit as a second image on an external surface, and a controller configured to detect a touch input on the touchscreen display unit, and to control the projector module to alter the displayed second image based on the detected touch input.

Pursuant to 35 U.S.C. §119(a), this application claims the benefit of earlier filing date and right of priority to Korean Application No. 10-2009-0098223, filed on Oct. 7, 2008, the contents of which are hereby incorporated by reference herein in their entirety.

### BACKGROUND OF THE INVENTION

1. Field of the Invention

The present invention relates to a mobile terminal and corresponding method for projecting an image displayed on the mobile terminal to an external surface.

2. Discussion of the Related Art

Mobile terminals now provide many additional services beside the basic call service. For example, user's can now access the Internet, play games, watch videos, listen to music, capture images and videos, record audio files, etc. Mobile terminals also now provide broadcasting programs such that user can watch television shows, sporting programs, videos etc.

However, because the terminal is small in size, it is difficult for the user to clearly see information displayed on the terminal, and to manipulate different menu options provided on the mobile terminal.

### SUMMARY OF THE INVENTION

Accordingly, one object of the present invention is to address the above-noted and other problems.

Another object of the present invention is to provide a mobile terminal and corresponding method for projecting information displayed on the mobile terminal to an external surface.

Yet another object of the present invention is to provide a mobile terminal and corresponding method for controlling a projected image by manipulating the corresponding image being displayed on the mobile terminal.

To achieve these objects and other advantages and in accordance with the purpose of the invention, as embodied and broadly described herein, the present invention provides in one aspect a mobile terminal including a touchscreen display unit configured to display at least a first image and to receive touch inputs, a projector module configured to project the first image displayed on the touchscreen display unit as a second image on an external surface, and a controller configured to detect a touch input on the touchscreen display unit, and to control the projector module to alter the displayed second image based on the detected touch input.

In another aspect, the present invention provides a method of controlling a mobile terminal, and which includes displaying at least a first image on a touchscreen display unit of the mobile terminal, projecting the first image displayed on the touchscreen display as a second image on an external surface, detecting a touch input on the touchscreen display unit; and altering the displayed second image based on the detected touch input.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram of a mobile terminal according to an embodiment of the present invention;

FIG. 2A is a front perspective diagram of a mobile terminal according to an embodiment of the present invention;

FIG. 2B is a rear perspective diagram of a mobile terminal according to an embodiment of the present invention;

FIGS. 3A and 3B are front diagrams of a mobile terminal according to an embodiment of the present invention;

FIG. 4 is a diagram for explaining a concept of proximity depth of a proximity sensor according to an embodiment of the present invention;

FIG. 5 includes overviews of a flip-type mobile terminal according to an embodiment of the present invention;

FIGS. 6A and 6B are diagrams for explaining a proximity touch recognizing area for detecting a proximity signal and a haptic area for generating a tactile effect according to an embodiment of the present invention;

FIGS. 7A-8B are overviews of a mobile terminal projecting images on an external surface according to an embodiment of the present invention;

FIG. 9 is a flowchart illustrating a method of controlling a mobile terminal according to an embodiment of the present invention;

FIGS. 10A and 10B are overviews of a mobile terminal projecting images on an external surface according to another embodiment of the present invention;

FIGS. 11A-11D are overviews of a mobile terminal projecting images on an external surface according to another embodiment of the present invention;

FIGS. 12A-12C are overviews of a mobile terminal projecting images on an external surface according to another embodiment of the present invention;

FIGS. 13A-13C are overviews of a mobile terminal projecting images on an external surface according to another embodiment of the present invention;

FIGS. 14A-14D are overviews of a mobile terminal projecting images on an external surface according to another embodiment of the present invention;

FIGS. 15A-15D are overviews of a mobile terminal projecting images on an external surface according to another embodiment of the present invention;

FIGS. 16A and 16B are overviews of a mobile terminal projecting images on an external surface according to another embodiment of the present invention;

FIGS. 17A and 17B are overviews of a mobile terminal projecting images on an external surface according to another embodiment of the present invention;

FIGS. 18A and 18B are overviews of a mobile terminal projecting images on an external surface according to another embodiment of the present invention;

FIGS. 19A-19D are overviews of a mobile terminal projecting images on an external surface according to another embodiment of the present invention;

FIGS. 20A and 20B are overviews of a mobile terminal projecting images on an external surface according to another embodiment of the present invention; and

FIGS. 21A and 21B are overviews of a mobile terminal projecting images on an external surface according to another embodiment of the present invention.

### DETAILED DESCRIPTION OF THE INVENTION

Hereinafter, a mobile terminal relating to embodiments of the present invention will be described below in more detail with reference to the accompanying drawings. Further, the mobile terminal described in the specification can include a cellular phone, a smart phone, a laptop computer, a digital broadcasting terminal, personal digital assistants (PDA), a portable multimedia player (PMP), a navigation system and so on.

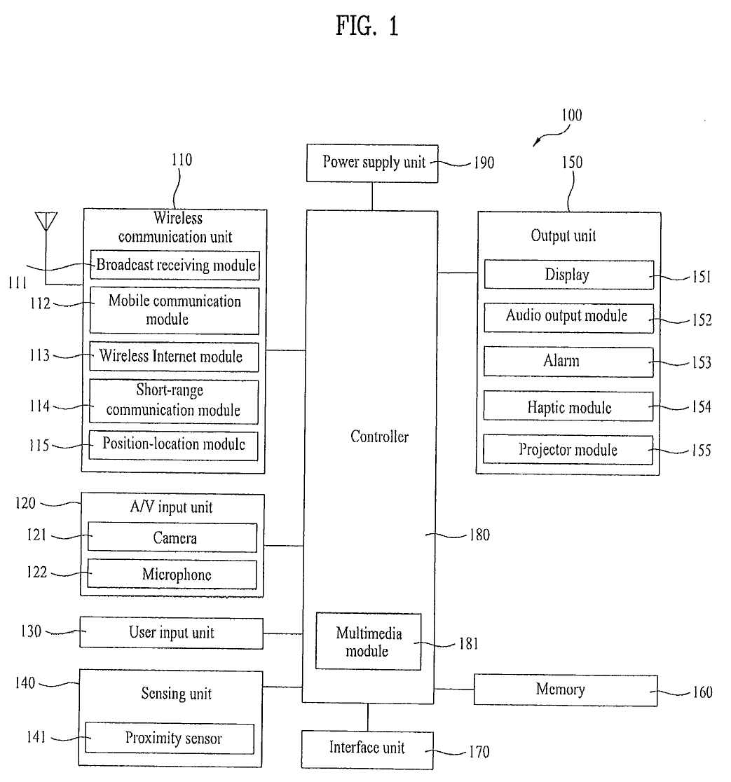

FIG. 1 is a block diagram of a mobile terminal 100 according to an embodiment of the present invention. As shown, the mobile terminal 100 includes a radio communication unit 110, an audio/video (A/V) input unit 120, a user input unit 130, a sensing unit 140, an output unit 150, a memory 160, an interface 170, a controller 180, and a power supply 190. Not all of the components shown in FIG. 1 are essential parts and the number of components included in the mobile terminal can be varied.

In addition, the radio communication unit 110 includes at least one module that enables radio communication between the mobile terminal 100 and a radio communication system or between the mobile terminal 100 and a network in which the mobile terminal 100 is located. For example, in FIG. 1, the radio communication unit 110 includes a broadcasting receiving module 111, a mobile communication module 112, a wireless Internet module 113, a local area communication module 114 and a position information module 115.

The broadcasting receiving module 111 receives broadcasting signals and/or broadcasting related information from an external broadcasting management server through a broadcasting channel. Further, the broadcasting channel can include a satellite channel and a terrestrial channel. Also, the broadcasting management server can be a server that generates and transmits broadcasting signals and/or broadcasting related information or a server that receives previously created broadcasting signals and/or broadcasting related information and transmits the broadcasting signals and/or broadcasting related information to a terminal. The broadcasting signals can include not only TV broadcasting signals, radio broadcasting signals and data broadcasting signals, but also signals in the form of a combination of a TV broadcasting signal and a radio broadcasting signal.

In addition, the broadcasting related information can be information on a broadcasting channel, a broadcasting program or a broadcasting service provider. The broadcasting related information can be provided even through a mobile communication network. In this instance, the broadcasting related information can be received by the mobile communication module 112. The broadcasting related information can also exist in various forms. For example, the broadcasting related information can exist in the form of an electronic program guide (EPG) of the digital multimedia broadcasting (DMB) system or in the form of an electronic service guide (ESG) of the digital video broadcast-handheld (DVB-H) system.

In addition, the broadcasting receiving module 111 receives broadcasting signals using various broadcasting systems. In particular, the broadcasting receiving module 111 can receive digital broadcasting signals using digital broadcasting systems such as the digital multimedia broadcasting-terrestrial (DMB-T) system, the digital multimedia broadcasting-satellite (DMB-S) system, the media forward link only (MediaFLO) system, and the DVB-H and integrated services digital broadcast-terrestrial (ISDB-T) system. The broadcasting receiving module 111 can also be constructed to be suited to broadcasting systems providing broadcasting signals other than the above-described digital broadcasting systems. The broadcasting signals and/or broadcasting related information received through the broadcasting receiving module 111 can also be stored in the memory 160.

Further, the mobile communication module 112 transmits/receives a radio signal to/from at least one of a base station, an external terminal, and a server on a mobile communication network. The radio signal can include a voice call signal, a video telephony call signal or data in various forms according to transmission and receiving of text/multimedia messages. The wireless Internet module 113 corresponds to a module for wireless Internet access and can be included in the mobile terminal 100 or externally attached to the mobile terminal 100. Wireless LAN (WLAN) (Wi-Fi), wireless broadband (Wibro), world interoperability for microwave access (Wimax), high speed downlink packet access (HSDPA) and so on can be used as a wireless Internet technique. The local area communication module 114 corresponds to a module for local area communication. Bluetooth, radio frequency identification (RFID), infrared data association (IrDA), ultra wideband (UWB) and ZigBee can be used as a local area communication technique.

In addition, the position information module 115 confirms or obtains the position of the mobile terminal 100. A global positioning system (GPS) module is a representative example of the position information module 115. Further, the GPS module 115 can calculate information on distances between one point (object) and at least three satellites and information on the time when the distance information is measured and apply trigonometry to the obtained distance information to obtain three-dimensional position information on the point (object) according to latitude, longitude and altitude coordinates at a predetermined time. Furthermore, a method of calculating position and time information using three satellites and correcting the calculated position and time information using another satellite is also used. In addition, the GPS module 115 continuously calculates the current position in real time and calculates velocity information using the position information.

Referring to FIG. 1, the A/V input unit 120 is used to input an audio signal or a video signal and includes a camera 121 and a microphone 122. The camera 121 processes image frames of still images or moving images obtained by an image sensor in a video telephony mode or a photographing mode. The processed image frames can be displayed on a display 151 included in the output unit 150. In addition, the image frames processed by the camera 121 can be stored in the memory 160 or transmitted to an external device through the radio communication unit 110. The mobile terminal 100 can also include at least two cameras according to constitution of the terminal.

Further, the microphone 122 receives an external audio signal in a call mode, a recording mode or a speed recognition mode and processes the received audio signal into electric audio data. The audio data can also be converted into a form that can be transmitted to a mobile communication base station through the mobile communication module 112 and output in the call mode. The microphone 122 can employ various noise removal algorithms for removing noise generated when the external audio signal is received.

In addition, the user input unit 130 receives input data for controlling the operation of the terminal from a user. The user input unit 130 can include a keypad, a dome switch, a touch pad (constant voltage/capacitance), jog wheel, jog switch and so on. The sensing unit 140 senses the current state of the mobile terminal 100, such as an open/close state of the mobile terminal 100, the position of the mobile terminal 100, whether a user touches the mobile terminal 100, the direction of the mobile terminal 100 and acceleration/deceleration of the mobile terminal 100 and generates a detection signal for controlling the operation of the mobile terminal 100. For example, the sensing unit 140 can sense whether a slide phone is opened or closed when the mobile terminal 100 is the slide phone. Furthermore, the sensing unit 140 can sense whether the power supply 190 supplies power and whether the interface 170 is connected to an external device. The sensing unit 140 can include a proximity sensor 141.

In addition, the output unit 150 generates visual, auditory or tactile output and in FIG. 1 includes the display 151, an audio output module 152, an alarm 153, a haptic module 154, and a projector module 155. The display 151 displays information processed by the mobile terminal 100. For example, the display 151 displays a UI or graphic user interface (GUI) related to a telephone call when the mobile terminal is in the call mode. The display 151 also displays a captured or/and received image, UI or GUI when the mobile terminal 100 is in the video telephony mode or the photographing mode.

The display 151 can also include at least one of a liquid crystal display, a thin film transistor liquid crystal display, an organic light-emitting diode display, a flexible display and a three-dimensional display. Some of these displays can be of a transparent type or a light transmission type, which is referred to as a transparent display. The transparent display also includes a transparent liquid crystal display. The rear structure of the display unit 151 can also be of the light transmission type. According to this structure, a user can see an object located behind the body of the mobile terminal 100 through an area of the body of the mobile terminal 100, which is occupied by the display 151.

Further, the mobile terminal 100 can include at least two displays 151 according to constitution of the terminal. For example, the mobile terminal 100 can include a plurality of displays that are arranged on a single face at a predetermined distance or integrated. Otherwise, the plurality of displays can be arranged on different sides. In addition, when the display 151 and a sensor sensing touch (referred to as a touch sensor hereinafter) form a layered structure, which is referred to as a touch screen hereinafter, the display 151 can be used as an input device in addition to an output device. The touch sensor can be in the form of a touch film, a touch sheet and a touch pad, for example.

Also, the touch sensor can be constructed such that it converts a variation in pressure applied to a specific portion of the display 151 or a variation in capacitance generated at a specific portion of the display 151 into an electric input signal. The touch sensor can also be constructed such that it can sense pressure of touch as well as the position and area of touch. When touch input is applied to the touch sensor, a signal corresponding to the touch input is transmitted to a touch controller. The touch controller then processes the signal and transmits data corresponding to the processed signal to the controller 180. Accordingly, the controller 180 can detect a touched portion of the display 151.

Referring to FIG. 1, the proximity sensor 141 can be located in an internal region of the mobile terminal 100, surrounded by the touch screen, or near the touch screen. The proximity sensor 141 senses an object approaching a predetermined sensing face or an object located near the proximity sensor 141 using an electromagnetic force or infrared rays without having mechanical contact. Further, the proximity sensor 141 has a lifetime longer than that of a contact sensor and has wide application. The proximity sensor 141 also includes a transmission type photo-electric sensor, a direct reflection type photo-electric sensor, a mirror reflection type photo-electric sensor, a high-frequency oscillating proximity sensor, a capacitive proximity sensor, a magnetic proximity sensor, an infrared proximity sensor, etc.

In addition, a capacitive touch screen is constructed such that a proximity of a pointer is detected through a variation in an electric field according to the proximity of the pointer. In this instance, the touch screen (touch sensor) can be classified as a proximity sensor. For convenience of explanation, an action of approaching the pointer to the touch screen while the pointer is not in contact with the touch screen such that the location of the pointer on the touch screen is recognized is referred to as a “proximity touch” and an action of bringing the pointer into contact with the touch screen is referred to as a “contact touch” in the following description. Also, a proximity touch point of the pointer on the touch screen means a point of the touch screen to which the pointer corresponds perpendicularly to the touch screen when the pointer proximity-touches the touch screen.

Further, the proximity sensor 141 senses a proximity touch and a proximity touch pattern (for example, a proximity touch distance, a proximity touch direction, a proximity touch velocity, a proximity touch time, a proximity touch position, a proximity touch moving state, etc.). Information corresponding to the sensed proximity touch action and proximity touch pattern can also be displayed on the touch screen.

Also, the audio output module 152 can output audio data received from the radio communication unit 110 or stored in the memory 160 in a call signal receiving mode, a telephone call mode or a recording mode, a speech recognition mode and a broadcasting receiving mode. The audio output module 152 also outputs audio signals related to functions (for example, a call signal incoming tone, a message incoming tone, etc.) performed in the mobile terminal 100. The audio output module 152 can include a receiver, a speaker, a buzzer, etc.

The alarm 153 outputs a signal for indicating a generation of an event of the mobile terminal 100. Examples of events generated in the mobile terminal 100 include receiving a call signal, receiving a message, inputting a key signal, inputting touch, etc. The alarm 153 can also output signals in forms different from video signals or audio signals, for example, a signal for indicating a generation of an event through vibration. The video signals or the audio signals can also be output through the display unit 151 or the audio output module 152.

In addition, the haptic module 154 generates various haptic effects that the user can feel. A representative example of the haptic effects is vibration. The intensity and pattern of vibration generated by the haptic module 154 can also be controlled. For example, different vibrations can be combined and output or sequentially output. The haptic module 154 can also generate a variety of haptic effects including an effect of stimulus according to an arrangement of pins vertically moving for a contact skin face, an effect of stimulus according to a jet force or sucking force of air through a jet hole or a sucking hole, an effect of stimulus of rubbing the skin, an effect of stimulus according to contact of an electrode, an effect of stimulus using an electrostatic force and an effect according to reproduction of cold and warmth using an element capable of absorbing or radiating heat in addition to vibrations. Further, the haptic module 154 can not only transmit haptic effects through direct contact but also allow the user to feel haptic effects through kinesthetic sense of his or her fingers or arms. The mobile terminal 100 can also include at least two or more haptic modules 154 according to constitution of the mobile terminal.

The projector module 155 is an element for performing an image projector function using the mobile terminal 100. That is, the projector module 155 can display an image, which is identical to or partially different at least from the image displayed on the display 151, on an external surface such as a wall or screen according to a control signal of the controller 180. In particular, the projector module 155 includes a light source generating light (e.g., laser) for projecting an image, an image producing unit for producing an image to be projected using the light generated from the light source, and a lens for enlarging the image to be projected in a predetermined focus distance. In addition, the projector module 155 can include an adjustment device for adjusting an image projected direction by mechanically moving the lens or the whole module.

Further, the projector module 155 can be classified into a CRT (cathode ray tube) module, an LCD (liquid crystal display) module, a DLP (digital light processing) module or the like according to a device type of a display mechanism. In particular, the DLP module is operated by the mechanism of enabling the light generated from the light source to reflect on a DMD (digital micro-mirror device) chip and can be advantageous for the downsizing of the projector module 151. Preferably, the projector module 155 can be provided in a length direction of a lateral, front or backside direction of the mobile terminal 100. The projector module 155 can also be provided to any portion of the mobile terminal 100.

In addition, the memory 160 stores a program for the operation of the controller 180 and temporarily stores input/output data (for example, phone book, messages, still images, moving images, etc.). The memory 160 can also store data about vibrations and sounds in various patterns, which are output when a touch input is applied to the touch screen. The memory 160 can include at least one of a flash memory, a hard disk type memory, a multimedia card micro type memory, a card type memory (for example, SD or XD memory), a random access memory (RAM), a static RAM (SRAM), a read-only memory (ROM), an electrically erasable programmable ROM (EEPROM), a programmable ROM (PROM) magnetic memory, a magnetic disk and an optical disk. The mobile terminal 100 can also operate in relation to a web storage performing the storing function of the memory 160 on the Internet.

Further, the interface 170 serves as a path to all external devices connected to the mobile terminal 100. The interface 170 receives data or power from the external devices and transmits the data or power to the internal components of the mobile terminal 100 or transmits data of the mobile terminal 100 to the external devices. The interface 170 can also include a wired/wireless headset port, an external charger port, a wired/wireless data port, a memory card port, a port for connecting a device having a user identification module, an audio I/O port, a video I/O port, an earphone port, etc., for example.

In addition, an identification module is a chip that stores information for authenticating the authority to use the mobile terminal 100 and can include a user identify module (UIM), a subscriber identify module (SIM) and a universal subscriber identify module (USIM). A device (referred to as an identification device hereinafter) including the identification module can be manufactured in the form of a smart card. Accordingly, the identification device can be connected to the mobile terminal 100 through a port.

Also, the interface 170 can serve as a path through which power from an external cradle is provided to the mobile terminal 100 when the mobile terminal 100 is connected to the external cradle or a path through which various command signals input by the user through the cradle to the mobile terminal 100. The various command signals or power input from the cradle can be used as a signal for confirming whether the mobile terminal 100 is correctly set in the cradle.

The controller 180 controls the overall operation of the mobile terminal. For example, the controller 180 performs control and processing for voice communication, data communication and video telephony. In FIG. 1, the controller 180 includes a multimedia module 181 for playing multimedia. The multimedia module 181 can be included in the controller 180 or separated from the controller 180. Further, the controller 180 can perform a pattern recognition process capable of recognizing handwriting input or picture-drawing input applied to the touch screen as characters or images. In addition, the power supply 190 receives external power and internal power and provides power required for the operations of the components of the mobile terminal under the control of the controller 180.

Further, various embodiments of the present invention can be implemented in a computer or similar device readable recording medium using software, hardware or a combination thereof, for example. According to a hardware implementation, the embodiments of the present invention can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units for executing functions. The embodiments can also be implemented by the controller 180.

According to a software implementation, embodiments such as procedures or functions can be implemented with a separate software module executing at least one function or operation. Software codes can be implemented according to a software application written in an appropriate software language. Furthermore, the software codes can be stored in the memory 160 and executed by the controller 180.

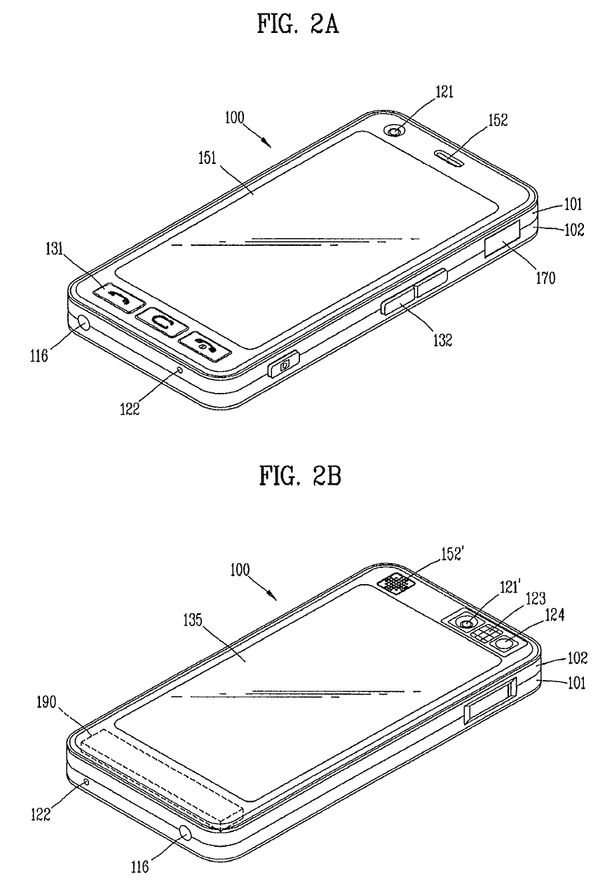

Next, FIG. 2A is a front perspective view of a mobile terminal or a handheld terminal 100 according to an embodiment of the present invention. As shown, the mobile terminal 100 is a bar type terminal body. However, the present invention is not limited to a bar type terminal and can be applied to terminals of various types including a slide type, folder type, swing type and swivel type terminals having at least two bodies that are relatively movably combined.

In addition, the terminal body includes a case (a casing, a housing, a cover, etc.) forming the exterior of the terminal 100. In the present embodiment, the case is divided into a front case 101 and a rear case 102. Various electronic components are also arranged in the space formed between the front case 101 and the rear case 102. At least one middle case can be additionally arranged between the front case 101 and the rear case 102. The cases can also be formed of plastics through injection molding or be made of a metal material such as stainless steel (STS) or titanium (Ti).

In addition, the display 151, the audio output unit 152, the camera 121, user input units 131 and 132 of the user input unit 130 (FIG. 1), the microphone 122 and the interface 170 are arranged in the terminal body, specifically, in the front case 101. Also, the display 151 occupies most part of the main face of the front case 101. The audio output unit 152 and the camera 121 are arranged in a region in proximity to one of both ends of the display 151 and the user input unit 131 and the microphone 122 are located in a region in proximity to the other end of the display 151. In addition, the user input unit 132 and the interface 170 are arranged on the sides of the front case 101 and the rear case 102.

Further, the user input unit 130 is operated to receive commands for controlling the operation of the handheld terminal 100 and can include the operating units 131 and 132. The operating units 131 and 132 can be referred to as manipulating portions and employ any tactile manner in which a user operates the operating units 131 and 132 while having tactile feeling. The operating units 131 and 132 can also receive various inputs. For example, the operating unit 131 receives commands such as start, end and scroll, and the second operating unit 132 receives commands such as control of the volume of sound output from the audio output unit 152 or conversion of the display 151 to a touch recognition mode.

Next, FIG. 2B is a rear perspective view of the mobile terminal 100 shown in FIG. 2A according to an embodiment of the present invention. Referring to FIG. 2B, a camera 121′ is additionally attached to the rear side of the terminal body, that is, the rear case 102. The camera 121′ has a photographing direction opposite to that of the camera 121 shown in FIG. 2A and can have pixels different from those of the camera 121 shown in FIG. 2A. For example, it is preferable that the camera 121 has low pixels such that it can capture an image of the face of a user and transmit the image to a receiving part for video telephony, while the camera 121′ has high pixels because it captures an image of a general object and does not immediately transmit the image in many instances. The cameras 121 and 121′ can also be attached to the terminal body such that they can be rotated or pop-up.

A flash bulb 123 and a mirror 124 are also arranged in proximity to the camera 121′. The flash bulb 123 lights an object when the camera 121′ takes a picture of the object, and the mirror 124 is used for the user to look at his/her face in the mirror when the user wants to self-photograph himself/herself using the camera 121′. An audio output unit 152′ is also provided on the rear side of the terminal body. The audio output unit 152′ can thus achieve a stereo function with the audio output unit 152 shown in FIG. 2A and be used for a speaker phone mode when the terminal is used for a telephone call.

A broadcasting signal receiving antenna 124 is also attached to the side of the terminal body in addition to an antenna for telephone calls. The antenna 124 constructing a part of the broadcasting receiving module 111 shown in FIG. 1 can be set in the terminal body such that the antenna 124 can be retracted from the terminal body. Further, the power supply 190 for providing power to the handheld terminal 100 is set in the terminal body. The power supply 190 can be included in the terminal body or detachably attached to the terminal body. A touch pad 135 for sensing touch is also attached to the rear case 102. The touch pad 135 can be of a light transmission type as the display 151. In this instance, if the display 151 outputs visual information through both sides thereof, the visual information can be recognized through the touch pad 135. The information output through both sides of the display 151 can also be controlled by the touch pad 135. Otherwise, a display is additionally attached to the touch pad 135 such that a touch screen can be arranged even in the rear case 102.

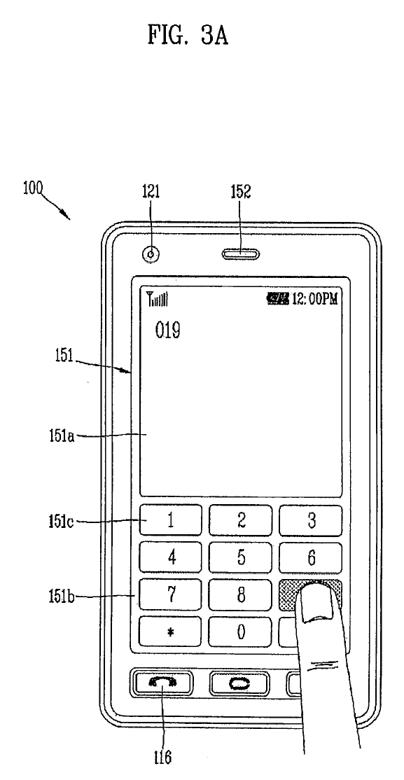

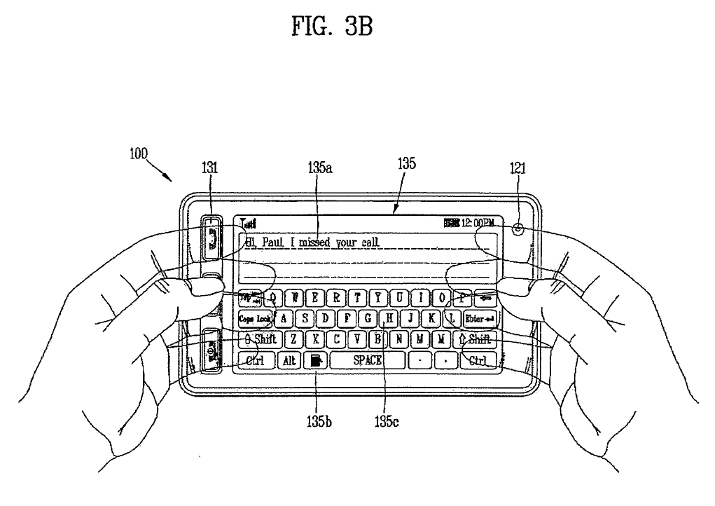

The touch pad 135 also operates in connection with the display 151 of the front case 101. The touch pad 135 can be located in parallel with the display 151 behind the display 151, and can be identical to or smaller than the display 151 in size. Interoperations of the display 151 and the touch pad 135 will now be described with reference to FIGS. 3A and 3B.

In more detail, FIGS. 3A and 3B are front views of the mobile terminal 100 for explaining an operating state of the handheld terminal according to an embodiment of the present invention. In addition, the display 151 can display various types of visual information in the form of characters, numerals, symbols, graphic or icons. To input the information, at least one of the characters, numerals, symbols, graphic and icons are displayed in predetermined arrangement in the form of a keypad. This keypad can be referred to as a ‘soft key’ key pad.

Further, FIG. 3A shows that touch applied to a soft key is input through the front side of the terminal body. The display 151 can also be operated through the overall area. Otherwise, the display 151 can be divided into a plurality of regions and operated. In the latter instance, the display 151 can be constructed such that the plurality of regions interoperate. For example, an output window 151a and an input window 151b are respectively displayed in upper and lower parts of the display 151. The input window 151b displays soft keys 151c that represent numerals used to input numbers such as telephone numbers. When a soft key 151c is touched, a numeral corresponding to the touched soft key is displayed on the output window 151a. When the user operates a first operating unit 116, the controller 180 attempts to connect a call corresponding to a telephone number displayed on the output window 151a.

Next, FIG. 3B shows that touch applied to soft keys is input through the rear side of the terminal body. FIG. 3B also shows the landscape of the terminal body, while FIG. 3A shows the portrait of the terminal body. That is, the display 151 can be constructed such that an output image is converted according to the direction in which the terminal body is located. Further, FIG. 3B shows the operation of the mobile terminal 100 in a text input mode. As shown, the display 151 displays an output window 135a and an input window 135b. A plurality of soft keys 135c indicating at least one of characters, symbols and numerals are arranged in the input window 135b. The soft keys 135c can also be arranged in the form of QWERTY keys.

When the soft keys 13 5c are touched through the touch pad 135, characters, numerals and symbols corresponding to the touched soft keys 135c are displayed on the output window 135a. Touch input through the touch pad 135 can prevent the soft keys 135c from being covered with the user's fingers when the soft keys 135c are touched as compared to touch input through the display 151. When the display 151 and the touch pad 135 are transparent, fingers located behind the terminal body can be seen by the user, and thus touch input can be performed more accurately.

In addition, the display 151 or the touch pad 135 can be constructed such that it receives touch input in a scroll manner. That is, the user can scroll the display 151 or the touch pad 135 to move an object displayed on the display 151, for example, a cursor or a pointer located on an icon. Furthermore, when the user moves his or her finger on the display 151 or the touch pad 135, the finger moving path can be visually displayed on the display 151. This will be useful to edit an image displayed on the display 151.

Also, when the display unit 151 (touch screen) and the touch pad 135 are simultaneously touched in a predetermined period of time, a specific function of the terminal can be executed. This action can include when the user clamps the terminal body using the thumb and the index finger. The specific function can include activation or inactivation of the display 151 or the touch pad 135, for example.

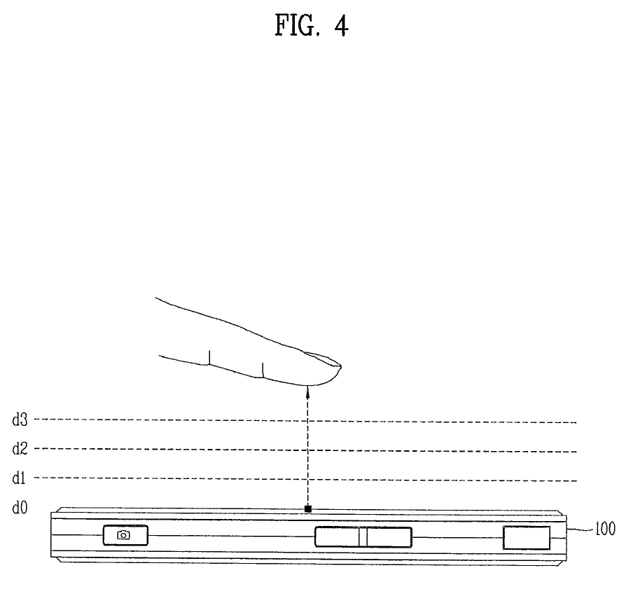

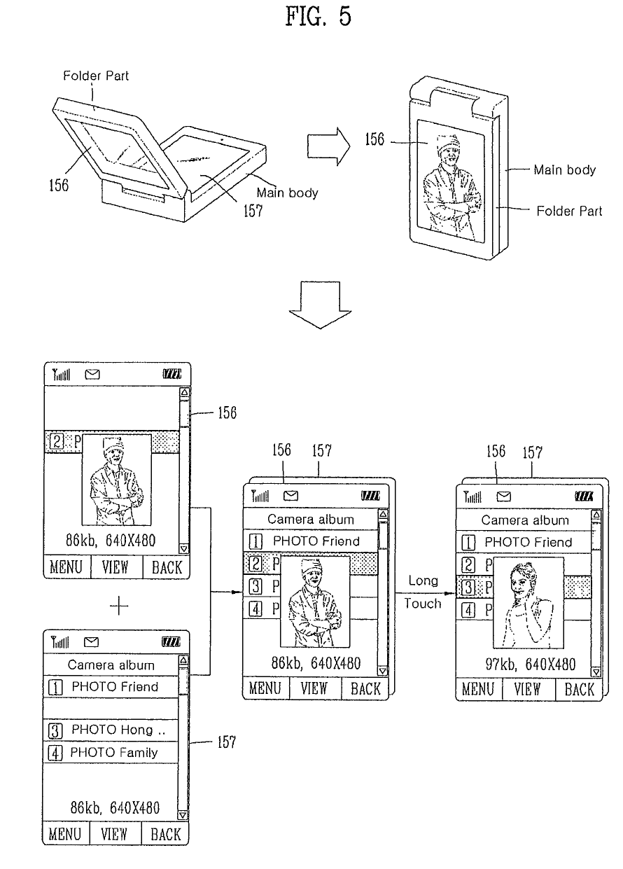

The proximity sensor 141 described with reference to FIG. 1 will now be explained in more detail with reference to FIG. 4. That is, FIG. 4 is a conceptional view for explaining a proximity depth of the proximity sensor 141. As shown in FIG. 4, when a pointer such as a user's finger approaches the touch screen, the proximity sensor 141 located inside or near the touch screen senses the approach and outputs a proximity signal. In addition, the proximity sensor 141 can be constructed such that it outputs a proximity signal according to the distance between the pointer approaching the touch screen and the touch screen (referred to as “proximity depth”). The distance in which the proximity signal is output when the pointer approaches the touch screen is referred to as a detection distance. The proximity depth can be known by using a plurality of proximity sensors having different detection distances and comparing proximity signals respectively output from the proximity sensors.

Further, FIG. 4 shows the section of the touch screen in which proximity sensors capable of sensing three proximity depths are arranged. Proximity sensors capable of sensing less than three or more than four proximity depths can be arranged in the touch screen. Specifically, when the pointer completely comes into contact with the touch screen (D0), it is recognized as contact touch. When the pointer is located within a distance D1 from the touch screen, it is recognized as proximity touch of a first proximity depth, and when the pointer is located in a range between the distance D1 and a distance D2 from the touch screen, it is recognized as proximity touch of a second proximity depth. Further, when the pointer is located in a range between the distance D2 and a distance D3 from the touch screen, it is recognized as proximity touch of a third proximity depth, and when the pointer is located at longer than the distance D3 from the touch screen, it is recognized as cancellation of the proximity touch.

Accordingly, the controller 180 can recognize the proximity touch as various input signals according to the proximity distance and proximity position of the pointer with respect to the touch screen and perform various operation controls according to the input signals.

Embodiments of the present invention will now be explained in more detail. The embodiments also refer to the display 151 as a touch screen. A touch also includes both a proximity touch and a direct touch in the following description. Furthermore, touch input includes every possible touch according to variations in the number of touches, duration, behavior and form of a touch, such as various input signals corresponding to touch variations, for example, touch down, touch up, a lapse of predetermined touch duration, drag and drop, etc.

Next, FIG. 5 is a conceptual diagram for exampling a method of controlling a touch action when a pair of displays 156 and 157 are overlapped with each other. The terminal shown in FIG. 5 is a folder type terminal in which a folder part is connected to a main body. The folder part can then be folded or unfolded with respect to the main part. Further, the first display 156 provided to the folder part is a light-transmittive or transparent type such as TOLED, while the second display 157 provided to the main body may be a non-transmittive type such as an LCD. Each of the first and second display 156 and 157 can also include a touchscreen. For instance, if a touch (contact touch or proximity touch) to the first display or TOLED 156 is detected, the controller 180 selects or excutes at least one image from an image list displayed on the TOLED 156 according to a touch type and a touch duration.

The following description refers to a method of controlling information displayed on the two displays 156 and 157. In addition, the description refers input types such as a touch, a long touch, a long-touch & drag and the like. As shown in FIG. 5, in the overlapped state (a state that the mobile terminal is closed or folded), the TOLED 156 is configured to be overlapped with the LCD 157. In this state, if a touch different from a touch for controlling an image displayed on the TOLED 156, e.g., a long touch (e.g., a touch having a duration of at least 2 seconds) is detected, the controller 180 enables at least one image to be selected from an image list displayed on the LCD 157 according to the touched touch input. The result from executing the selected image is displayed on the TOLED 156.

In addition, the user can also use the long touch input operation to selectively shift a specific one of the entities displayed on the LCD 157 to the TOLED 156 (without an action for executing the corresponding entity). In particular, if a user performs a long touch on a prescribed region of the TOLED 156 corresponding to a specific entity of the LCD 157, the controller 180 controls the corresponding entity to be displayed by being shifted to the TOLED 156. Meanwhile, an entity displayed on the TOLED 156 can be displayed by being shifted to the LCD 157 according to such a prescribed touch input to the TOLED 156 as flicking, swirling and the like. FIG. 5 illustrates a second menu displayed on the LCD 157 by being shifted to the TOLED 156.

Also, when another input (e.g., a dragging operation) is additionally detected together with the long touch input operation, the controller 180 executes a function associated with an image selected by the long touch operation so that a preview picture for the image can be displayed on the TOLED 156, for example. FIG. 5 illustrates a preview (picture of a male) for a second menu (image file) being performed. In addition, while the preview image is output, and if a dragging touch operation toward a different image is additionally performed on the TOLED 156 while maintaining the long touch operation, the controller 180 shifts a selection cursor (or a selection bar) of the LCD 157 and then displays the image selected by the selection cursor on the preview picture (picture of female). Thereafter, after completing the long touch and dragging operation, the controller 180 displays the initial image selected by the long touch operation.

Further, the touch action (long touch and dragging action) can also be applied when a slide action (a proximity touch operation corresponding to the dragging operation) is detected together with a long proximity touch (e.g., a proximity touch maintained for at least 2 or 3 seconds) to the TOLED 156. When a touch action differing from the above-mentioned touch actions is detected, the controller 180 operates in the same manner as a standard or predefined touch controlling method. The method of controlling the touch action in the overlapped state is also applicable to a terminal having a single display. Further, the method of controlling the touch action in the overlapped state is applicable to terminals differing from the folder type terminal having a dual display as well.

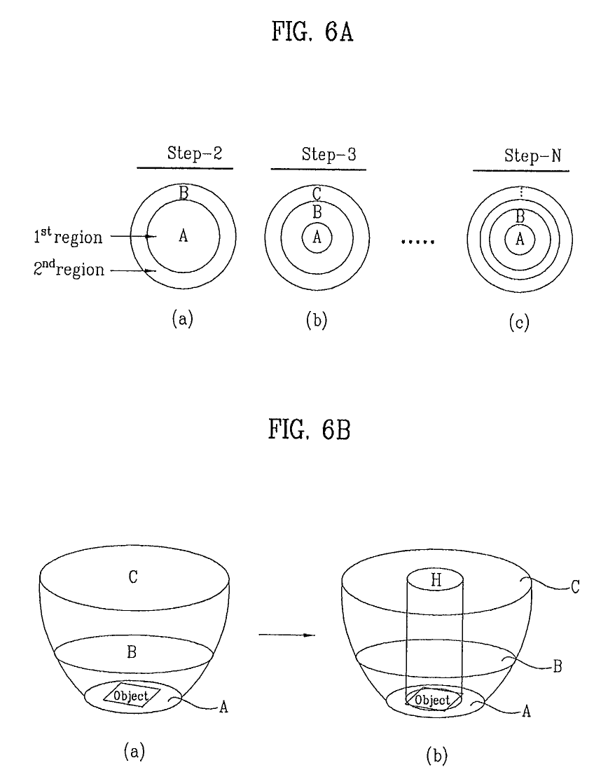

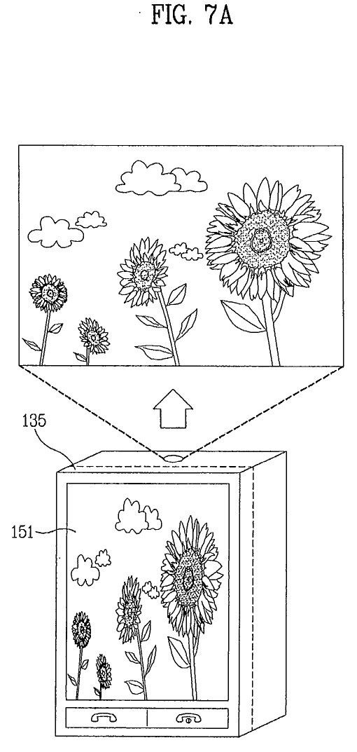

Next, FIGS. 6A and 6B are diagrams illustrating a proximity touch recognition area and a tactile effect generation region. In more detail, FIG. 6A represents an object as an icon, a menu item and the like in a circle type for clarity and convenience of explanation. As shown in FIG. 6A(a), a region for displaying an object on the display 151 can be divided into a first region A at a central part and a second region B enclosing the first region A. Further, the first and second regions A and B can be configured to generate tactile effects differing from each other in strength or pattern. For instance, the first and second regions can be configured to generate 2-step vibrations by outputting a first vibration if the second region B is touched or outputting a second vibration greater than the first vibration if the first region A is touched.

In addition, when both of the proximity touch recognition region and the haptic region are simultaneously set in the region having the object displayed therein, it is possible to set the haptic region for generating the tactile effect to be different from the proximity touch recognition region for detecting the proximity signal. In particular, it is possible to set the haptic region to be narrower or wider than the proximity touch recognition region. For instance, in FIG. 6A(a), the proximity touch recognition region can be set to the area including both of the first and second regions A and B, and the haptic region can be set to the first region A.

Further, as shown in FIG. 6A(b), the region having the object displayed therein can be discriminated into three regions A, B and C. Alternatively, the region having the object displayed therein can be discriminated into N regions (N>4) as shown in FIG. 6A(c). In addition, each of the divided regions can be set to generate a tactile effect having a different strength or pattern. Thus, when a region having a single object represented therein is divided into at least three regions, the haptic region and the proximity touch recognition region can be set to differ from each other according to a use environment.

Further, a size of the proximity touch recognition region of the display unit 151 can be set to vary according to a proximity depth. In particular, referring to FIG. 6B(a), the proximity touch recognition region decreases by C→B→A according to the proximity depth for the display 151. On the contrary, the proximity touch recognition region can also be configured to increase by C→B→A according to the proximity depth for the display unit 151. Further, the haptic region can be set to have a predetermined size, as the region ‘H’ shown in FIG. 6B (b) regardless of the proximity depth for the display 151. Also, when dividing the object-displayed region for the setting of the haptic region or the proximity touch recognition region, it is possible to use one of various schemes of horizontal/vertical division, radial division and combinations thereof as well as the concentric circle type division shown in FIG. 6A.

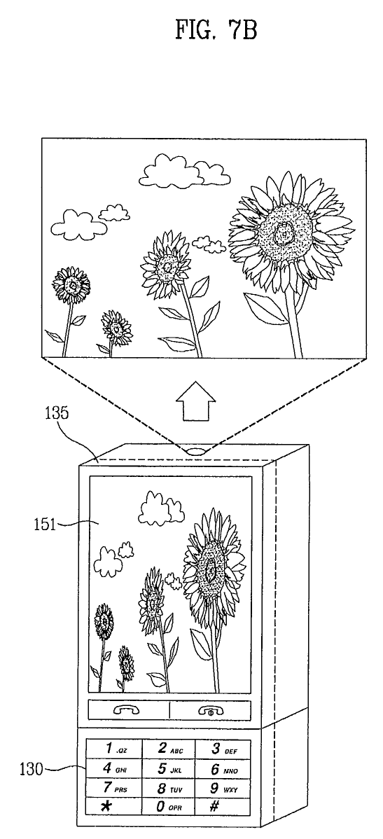

Next, FIGS. 7A and 7B illustrate the mobile terminal 100 projecting an image on an external surface according to a control operation conducted by the controller 180 using the projector module 155. In this instance, the image is stored in the memory 160 or is received from an external terminal via the wireless communication unit 110. Also, as shown in FIG. 7A, the display 151 and the touchpad 135 construct a layered touchscreen structure. FIG. 7B illustrates the mobile terminal 100 including the user input unit 130 along with the touchpad 135.

Thus, in FIGS. 7A and 7B, when the user touches the touchscreen or manipulates a key on the user input unit 130, the controller 180 controls an image display operation performed on the external surface to correspond to the detected touch or key manipulation. In addition, the image projected onto the external surface via the projector module 155 generally matches the image displayed on the touchscreen. For instance, the image displayed on the external surface may match the image displayed on the entire touchscreen or only a prescribed portion of the touchscreen.

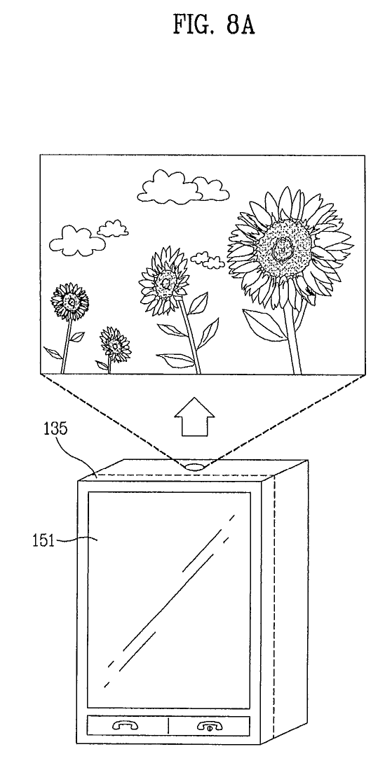

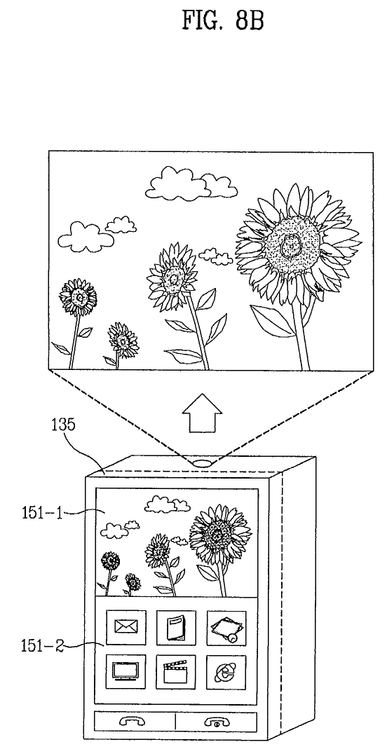

In addition, the touchscreen can be turned off so only the image is projected onto the external surface and is not additionally displayed on the touchscren as shown in FIG. 8A. This feature is particularly advantageous because when the display is turned off, the mobile terminal 100 uses less battery power. FIG. 8B illustrates the projector module 155 projecting only a portion 151-1 of the display 151 while the other portion 151-2 is not projected. FIG. 8B also illustrates both portions 151-1 and 151-2 of the display 151 being continuously displayed on the touch screen while the portion 151-1 is displayed on the external surface. In addition, the portion 151-1 of the display can be selectively turned off to save battery power.

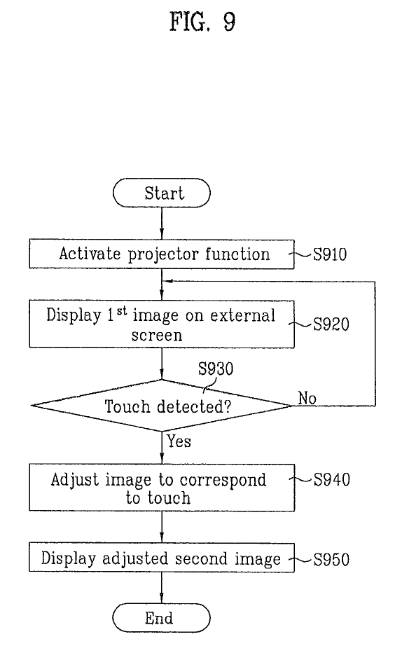

Next, FIG. 9 is a flowchart illustrating a method of controlling a mobile terminal according to an embodiment of the present invention. FIG. 1 will also be referred to throughout the rest of this description. As shown in FIG. 9, the controller 180 activates a projector function (i.e., the projector module 155) according to a selection made by a user (S910). For instance, if a user selects a projector function executing command key provided to the keypad or touchscreen or selects a menu item such as ‘view image via projector’ the controller 180 activates the projector function. That is, the controller 180 sets the projector module 155 to an operable mode such that the projector module 155 can display an image on an external surface.

In particular, as shown in FIG. 9, the controller 180 controls the projector module 155 to project a first image on an external surface such as a screen, wall, etc. (S920). As discussed above, the image projected and displayed on the external surface may match an image displayed on a prescribed area of the touchscreen. For instance, the image displayed on the external surface may match an image displayed on entire part or a specific area of the touchscreen or an image corresponding to a specific portion selected by a user.

The controller 180 then determines whether the user has touched the touchscreen (S930). As mentioned above, a sensor for detecting an external touch as the touchpad, the proximity sensor 141 and the like can be provided to the touchscreen. Therefore, the mobile terminal 100 can detect the touch action to the touchscreen using the touch sensor included in the touchscreen. Further, the touch action to the touchscreen can include a direct touch (or a contact touch) to the touchscreen, an indirect touch (or a proximity touch) to the touchscreen or the like.

Also, the detection of the touch action to the touchscreen can include detecting a touch point on the touchscreen, detecting a touch pattern, detecting a touch to a specific area, etc. In particular, the touch pattern can include a touch count, a touch duration, a touch size, a drag direction/distance/speed of a touch & drag action, or the like. Further, the touch pattern can include a proximity distance, a proximity speed, a proximity time, a proximity action, etc. for a proximity touch.

If the controller 180 detects the touch action to the touchscreen (Yes in S930), the controller 180 adjusts an image projected and displayed on the external surface according to the touch action (S940). For instance, the controller 180 displays an indicator at one point of the first image or identifies one portion of the first image to be displayed (e.g., allowing the user to ‘enlarge/set block/identity’ a portion of the first image). Moreover, the user can also set a second partial image of entire image including the first image set to a first partial image to be set to an adjusted image. The controller 180 then controls the projector module 155 to project and display the adjusted image (hereinafter named ‘second image’) on the external surface using (S950).

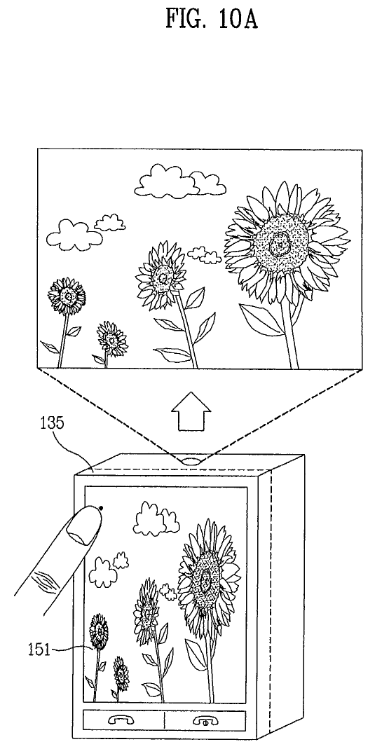

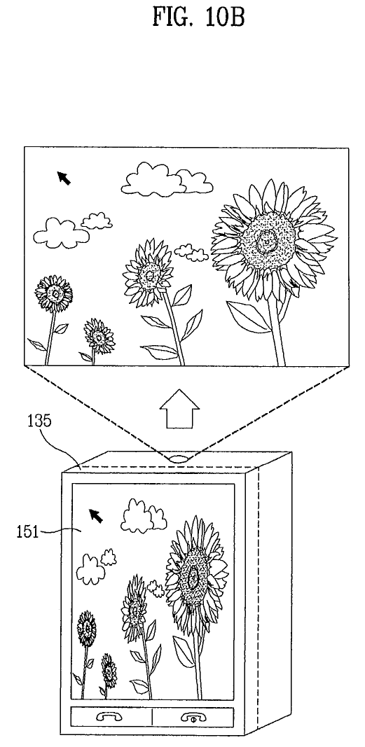

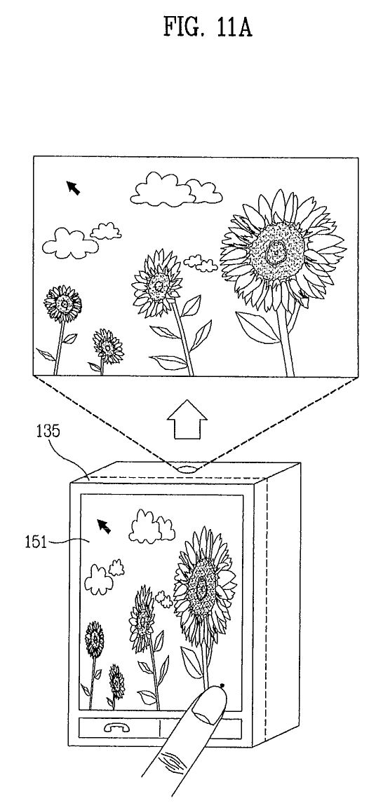

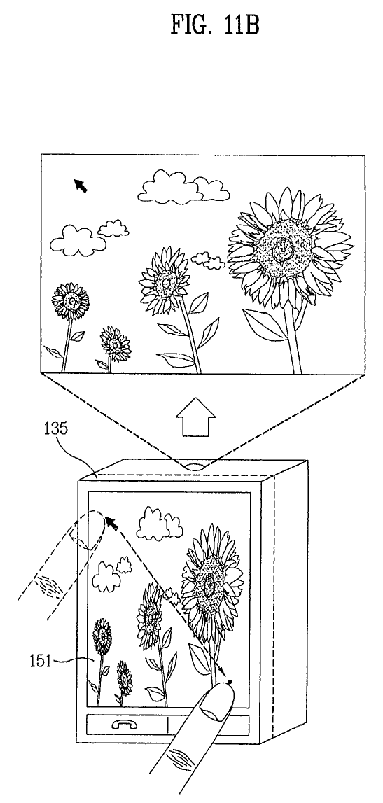

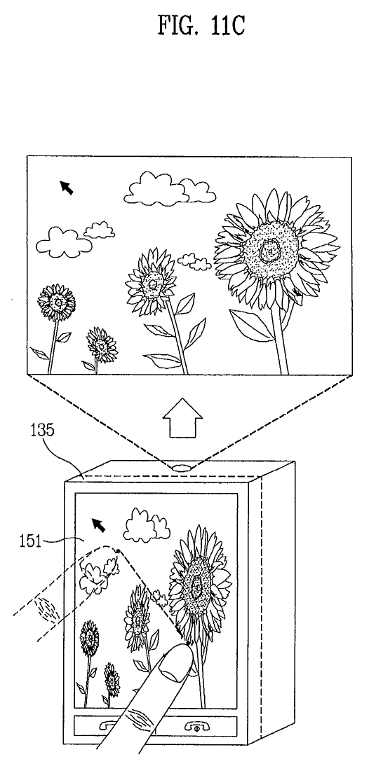

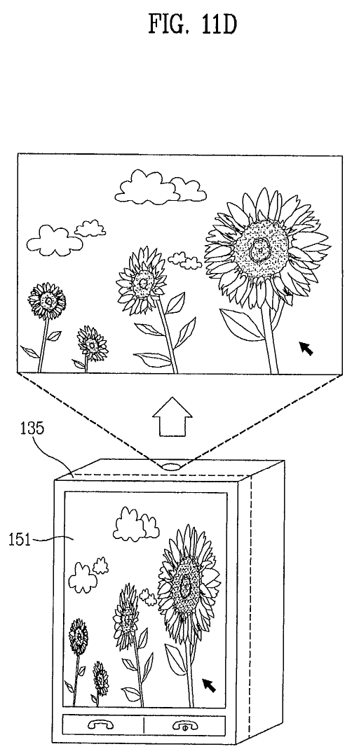

Next, FIGS. 10 and 11 will be referred to for explaining the adjusting step S930 in FIG. 9 in more detail. As discussed above, the controller 180 displays an indicator on the first image (i.e., the image displayed on the touchscreen of the mobile terminal) that the user can touch to adjust the second image projected onto the external surface. Any indicator can be used such as an image, icon, emoticon, symbol or the like to indicate a specific point on a screen. Preferably, the indicator includes a pointer positioned or moved on the touchscreen. Thus, after detecting the touch on the first image displayed on the touchscreen, the controller 180 controls the projector module 150 to project the first image as a second image onto the external surface. The user can then adjust and manipulate the projected second image by adjusting the first image displayed on the touch screen.

If the touch to the touchscreen is released in the course of displaying the image adjusted according to the touch detection, the controller 180 is able to display the image before the touch detection on the external screen. However, if the touch is released from the touchscreen in the course of displaying the image adjusted according to the touch detection, the controller 180 can keep displaying the adjusted image.

In more detail, FIGS. 10A and 10B are overviews illustrating one embodiment of the present invention. As shown in FIG. 10A, if the user touches a specific point of the first image displayed on the touchscreen, the controller 180 displays display an indicator on the second image (i.e., the projected image) located at the point touched by the user as shown in FIG. 10B. Further, the located point of the indicator coincides with the touch point or may be a point within a predetermined radius centering on the touch point. In an alternative embodiment, the controller 180 can display a plurality of indicators corresponding to a plurality of positions touched on the touchscreen (i.e., in a multiple touch input method).

Next, FIGS. 11A-11C illustrate the controller 180 shifting the indicator based on a touch operation performed on the first image displayed on the mobile terminal. In more detail, FIG. 11A illustrates the user touching a second position, FIG. 11B illustrates a situation in which the user touches the first position and performs a touch-and-drag operation towards or to the second position. As shown in FIG. 11D, the controller 180 shifts the indicator displayed on the second image to a position corresponding to the second position touched on the first image. FIG. 11C illustrates a similar situation where the user performs a touch and drag operation. In this example, the controller 180 shifts the indicator on the second image a distance and direction that substantially matches a distance and direction of the touch-and-drag operation performed on the first image. Thus, the controller 180 can display a shift progress of the indicator or can display a shift-completed indicator on the second image displayed on an external surface.

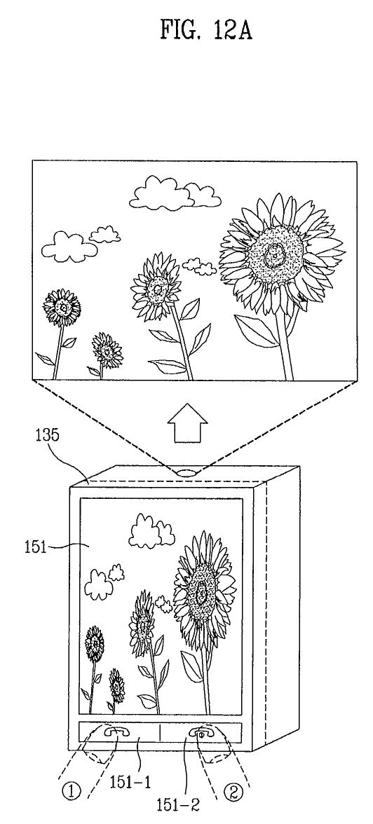

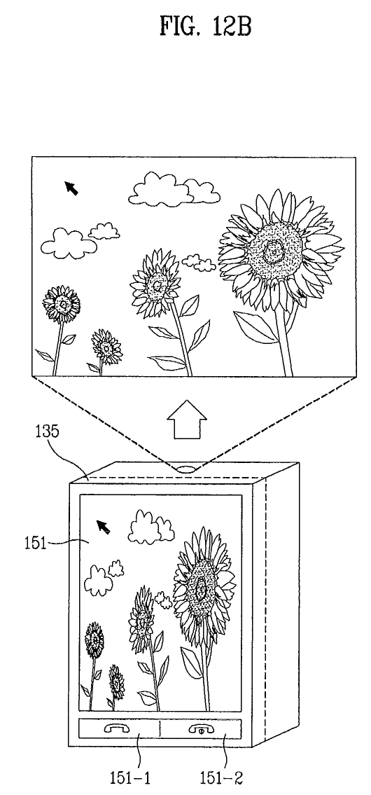

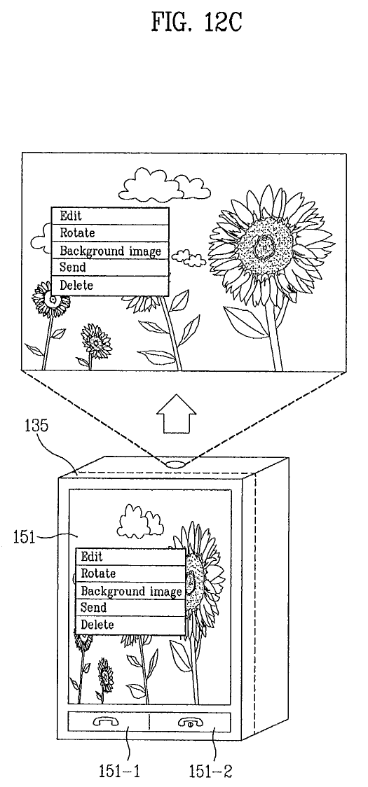

Next, FIGS. 12A-12C are overviews illustrating different functions being executed based on specific areas being touched on the touchscreen of the mobile terminal according to another embodiment of the present invention. For example, FIG. 12A illustrates areas 151-1 and 151-2 that the user can touch to perform different operations related to the second image displayed on the external surface. In more detail, in this embodiment, the area 151-1 corresponds to an ‘indicator display function’ that the user can touch to selectively display the indicator, and the area 151-2 corresponds to a ‘menu list display function’ that the user can touch to perform different menu options related to the second image displayed on the external surface.

As shown in FIG. 12A, the controller 180 does not display the indicator on the second image. However, as shown in FIG. 12B, when the user touches the area 151-1, the controller 180 displays the indicator on the second image as shown in FIG. 12B. In addition, when the user touches the second area 151-2, the controller 180 displays different menu options on the second image as shown in FIG. 12C. Thus, as shown in FIG. 12C, the user can then edit, rotate, set the image as a background image, send the image to someone else or delete the image.

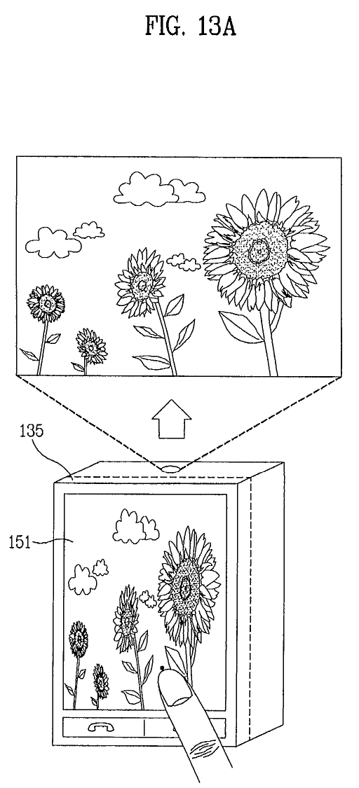

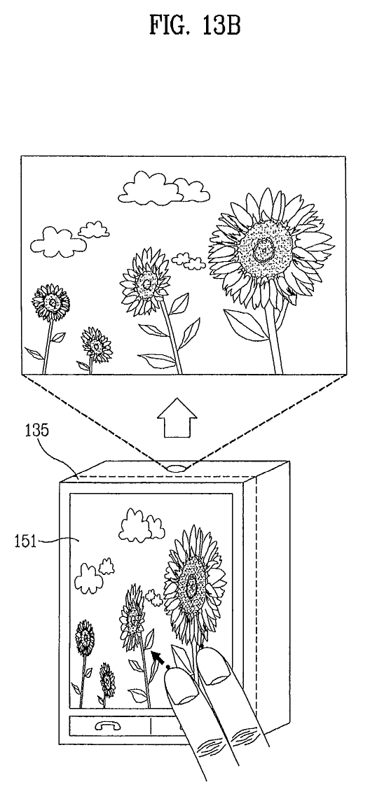

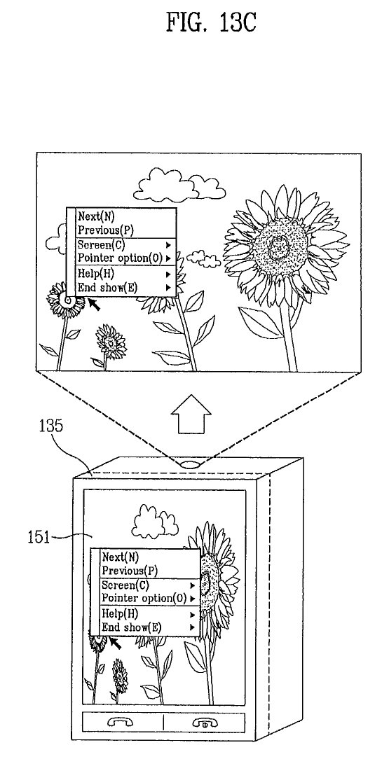

Next, FIGS. 13A-13C are overviews illustrating a operation being performed based on a particular touch operation according to yet another embodiment of the present invention (e.g., a touching action for a predetermined amount of time such a long touch operation, a multiple touch operation in which two or more points on the first image are touched, a single touch operation, etc.). In more detail, FIG. 13A illustrates the user touching once a particular location on the first image for a period longer than a predetermined period (e.g., a long touching operation), and FIG. 13B illustrates the user touching multiple positions on the first image. The can also perform a multiple touching operation in which the same position is touched multiple times within a predetermined time period.

Then, upon detecting the particular touch operation, the controller 180 performs a corresponding function. For example, FIG. 13C illustrates the controller 180 display a menu list that the user can use to perform different operations on the second image (e.g., move to a next or previous image, etc.). In addition, the particular touch operations can be linked to a predetermined operation and the controller 180 can refer to a table including the linked information to determine what operation to perform for each different touch operation.

In addition, if the indicator is displayed before the touch detection, the controller 180 can shift the indicator to a point for indicating a menu list after the touch detection. If the indicator is not displayed before the touch detection, the controller 180 can display the indicator at a point for indicating a menu list together with the menu list. Also, if a specific menu item in a menu list is selected (or touched), the controller 180 executes a function corresponding to the selected menu item.

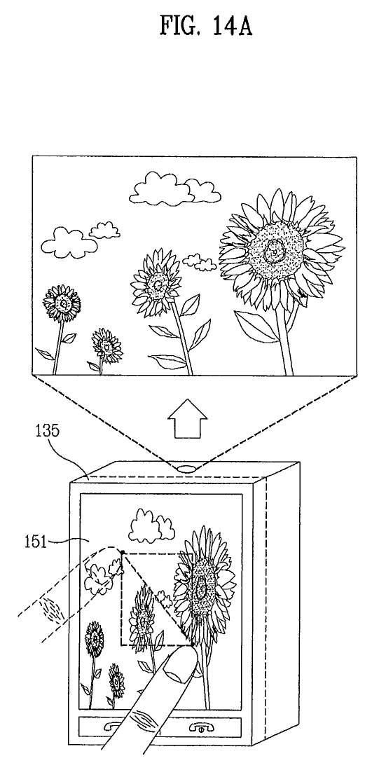

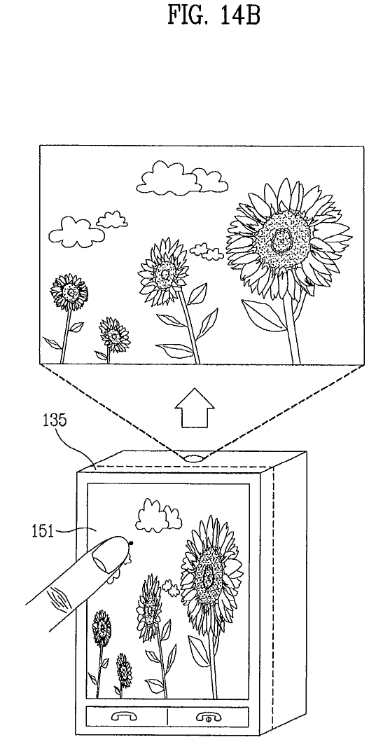

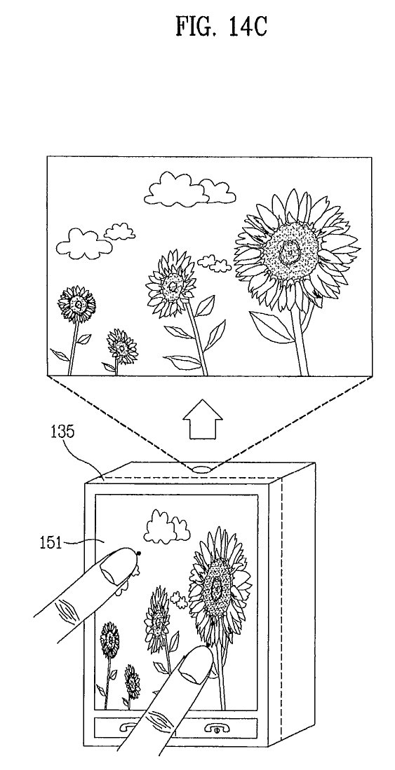

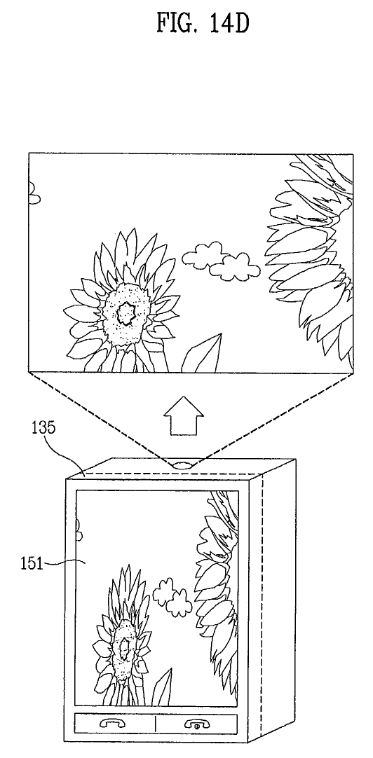

FIGS. 14A-14D are overviews illustrating other operations that can be performed based on a touch operation performed on the first image according to another embodiment of the present invention. For example, FIG. 14A illustrates the user performing a touch-and-drag operation from a first position to second position on the first image. In this example, the controller 180 displays a block having a diagonal line corresponding to the first and second touched points. Then, the controller 180 enlarges the second image displayed on the external surface based on the selected area of the first image as shown in FIG. 14D.

FIG. 14B is similar to FIG. 14A, but in this example, the user touches a single position on the first image (e.g., a predetermined number of times, for a predetermined time period, etc.). Then, the controller 180 displays an enlarged image (e.g., a block including the prescribed point as one vertex, a circle centering on the prescribed point, a polygon, etc.) of a predetermined portion of the first image with reference to the prescribed point on an external surface as shown in FIG. 14D. Similarly, FIG. 14C illustrates the user touching two positions on the first image. Then, in this instance, the controller 180 displays an enlarged image of a rectangular shape having a connection line between the first and second touched points as shown in FIG. 14D.

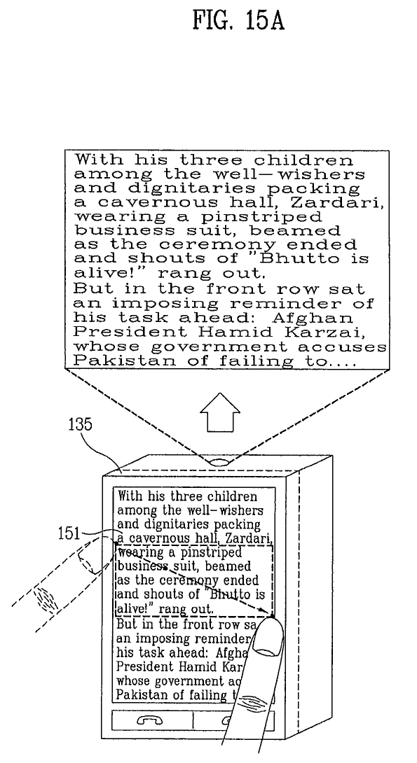

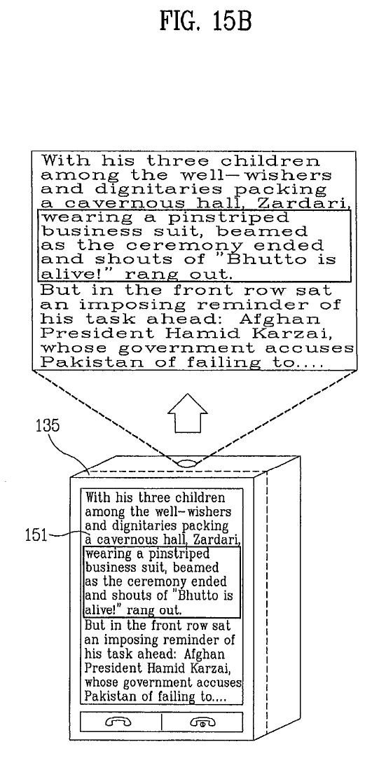

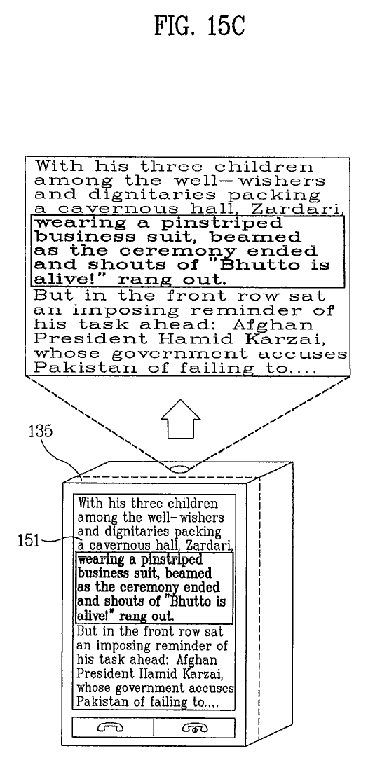

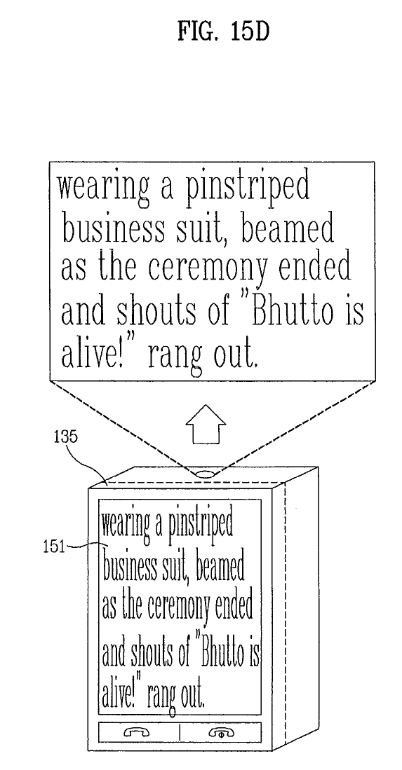

Next, FIGS. 15A-15D are overviews illustrating still other operations that can be performed based on a touch operation performed on the first image according to still another embodiment of the present invention. In more detail, FIG. 15 illustrates a portion of a document (WORD document, webpage, etc.) being displayed on the mobile terminal. As shown in FIG. 15, the user performs a touch-and-drag operation (or a multiple touching operation) so as to designate a portion of the displayed document. The controller 180 then displays a block designating the selected or identified portion of the document. FIG. 15A illustrates the controller 180 displaying the box using dotted lines indicating the user is in the process of the designating the particular portion. FIG. 15B illustrates the controller 180 displaying the block using solid lines indicating the user has completed the designation process. Note that the controller 180 also projects the block onto the second image displayed on the external surface.

In addition, FIG. 15C illustrates the controller 180 also highlighting the designated portion on both the first and second displayed images. In this example, the controller 180 uses a bold font to designate the selected portions. The controller 180 can also use different highlighting techniques such as using color/shading/brightness differing from the other text. As shown in FIG. 15D, the controller 180 can also enlarge the designated portion and only display the enlarged portion on both the mobile terminal and the external surface (or only show the portion displayed on the external surface as being enlarged).

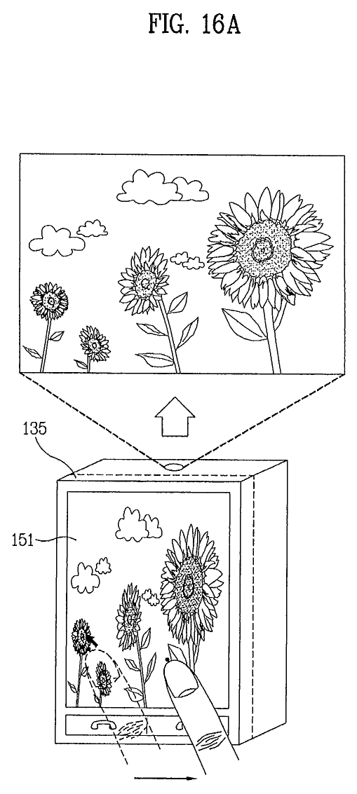

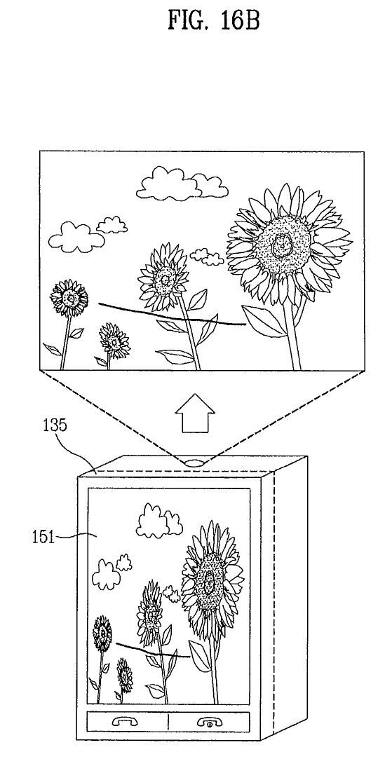

Next, FIGS. 16A-16B are overviews illustrating still other operations that can be performed based on a touch operation performed on the first image according to an embodiment of the present invention. In this example, and as shown in FIG. 16A, the user performs a touch-and-drag operation from a first point to a second point on the touchscreen (or a multiple touch operation). Then, as shown in FIG. 16B, the controller 180 displays a line connecting a path between the touched points. The line can be a straight line or a curved line. The user can then touch a portion of the line and drag the touched portion to thereby alter the second image displayed on the external screen, For example, with reference to FIG. 16B, the user can touch the middle portion of the line on the first image and drag the touched portion upwards. In this instance, the controller 180 can then move the corresponding portion of the second image upwards to make it appear that the flower is being extended or growing.

In addition, in FIGS. 16A and 16B, the controller 180 can display the line when the user first selects a menu item such as ‘path-recognizable display function’. The controller 180 then displays the line shown in FIG. 16B. The user can also select at least one of a virtual writing device (e.g., a ballpoint pen, a felt-tipped pen, a marker pen, etc.), path boldness, a path type (e.g., a curved line, a segment of a line, a cord, etc.), to use for the path-recognizable path.

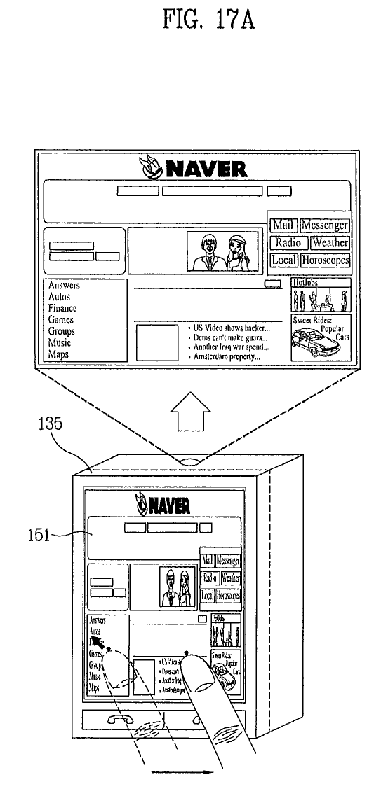

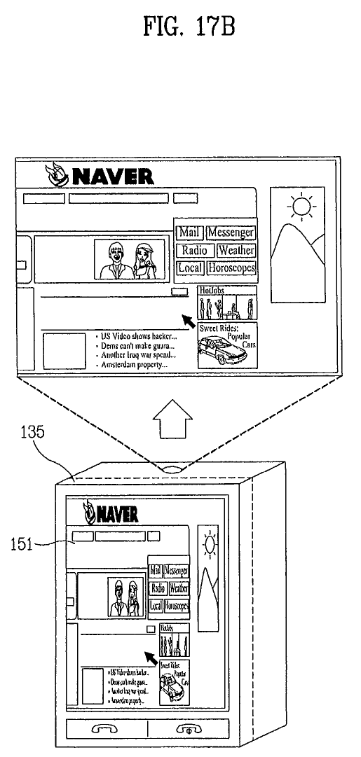

Next, FIGS. 17A-17B are overviews illustrating still other operations that can be performed based on a touch operation performed on the first image according to still another embodiment of the present invention. In this example, the information being displayed is assumed to be a web page. In more detail, as shown in FIG. 17A, the controller 180 displays a first portion of the web page. The first portion is also projected onto the external surface. Then, when the user performs a touch-and-drag operation (or a multiple touch operation), the controller 180 shifts the displayed image corresponding to the direction, distance or speed of touch-and-drag operation as shown in FIG. 17B. That is, when the direction and distance of the touch-and-drag operation are a ‘right direction’ and ‘1 cm’, respectively, the controller 180 shifts the displayed image in the corresponding direction.

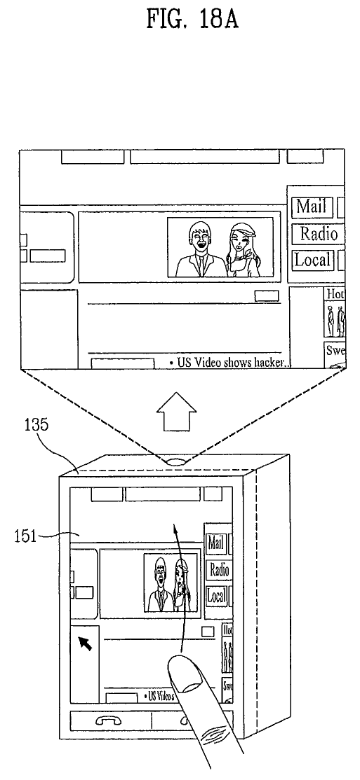

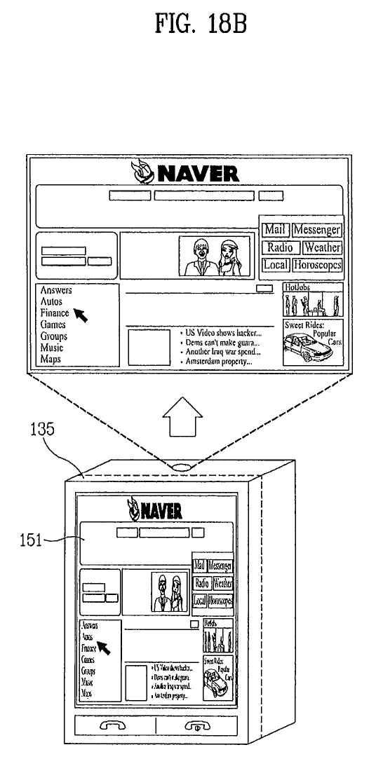

FIGS. 18A-18B are overviews illustrating still other operations that can be performed based on a touch operation performed on the first image according to an embodiment of the present invention. In this example, the user performs a flicking operation in which the user touches and flicks the first image in a particular direction. That is, as shown in FIG. 18A, the controller 180 displays a portion of a web page and the user touches and flicks the first image in an upward direction. The controller 180 then shifts the displayed image in the same corresponding direction as shown in FIG. 18B. The controller 180 can also shift the images in a same or similar corresponding speed based on a speed of the flicking operation.

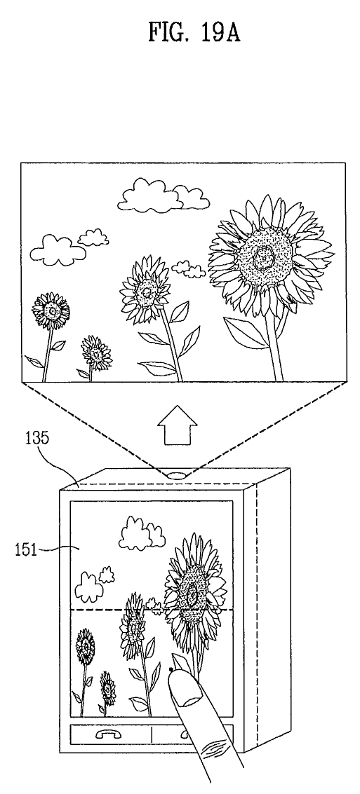

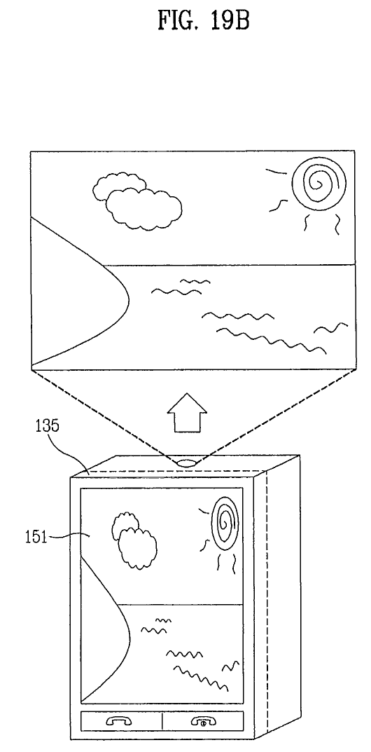

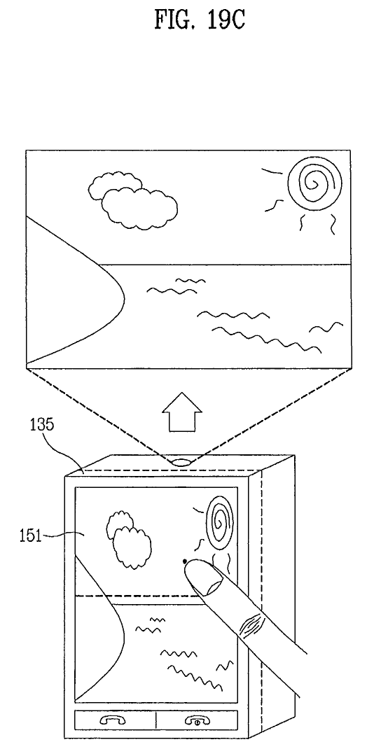

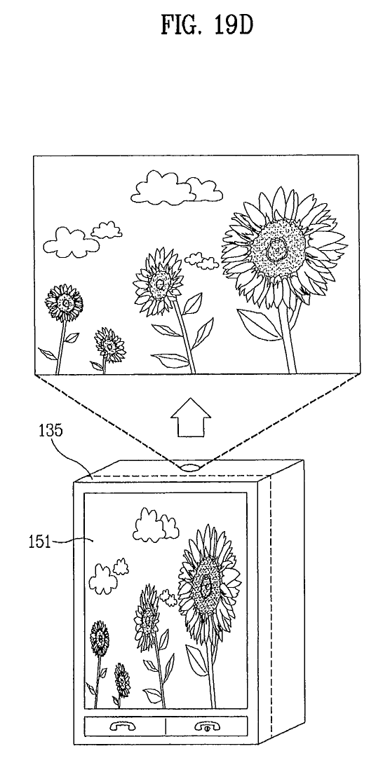

Next, FIGS. 19A-19D are overviews illustrating still other operations that can be performed based on a touch operation performed on the first image according to an embodiment of the present invention. In this example, the controller 180 sequence-shifts the images to correspond to a touch operation performed on a specific area on a touchscreen. In more detail, when the mobile terminal 100 displays a plurality of sequence-specified images on the external screen such as images corresponding to 1^{st}, 2^{nd}, 3^{rd}, . . . n^{th}, (n+1)^{th}, . . . (n+k)^{th} images, the user can scroll through the different images such that the different images are projected onto the external surface.

That is, as shown in FIG. 19A, the controller 180 divides the touchscreen into a plurality of areas and then displays specifies sequences of images on the touchscreen and on the external surface. For instance, when the n^{th} image is displayed on the external screen, if one area is selected on the mobile terminal, the controller 180 can display the (n−1)^{th} image (or and (n−1)^{th} image). Thus, as shown in FIG. 19A, when the n^{th} image is displayed on the external surface, and the user touches the first area on the touchscreen, the Controller 180 displays the (n+1)^{th} image on the external surface as shown in (FIG. 19B). Similarly, when the (n+1)^{th} image is displayed on the external surface, and the user touches the second area on the touchscreen as shown in FIG. 1 9C, the controller 180 displays the n^{th} image on the external surface as shown in (FIG. 19D).

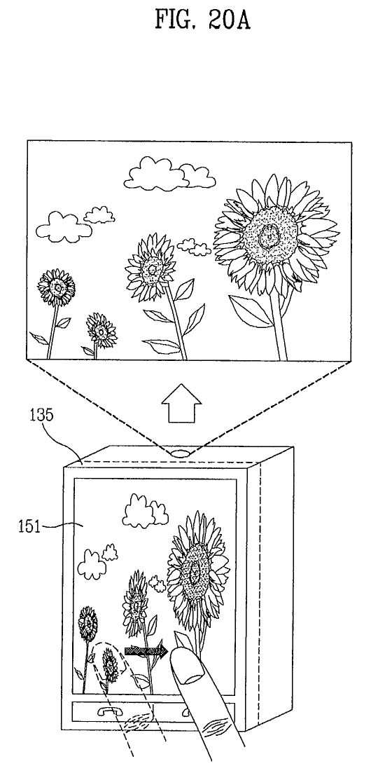

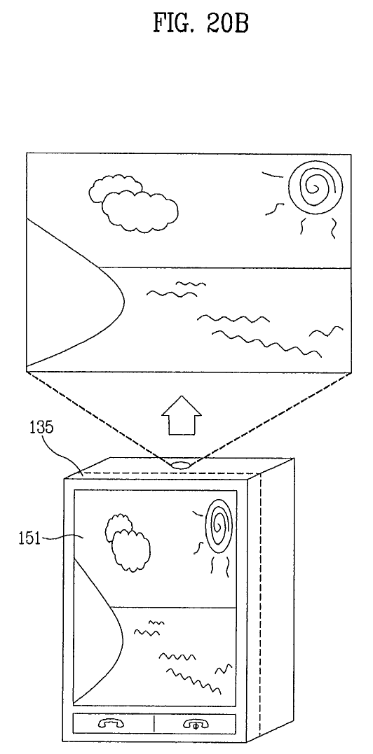

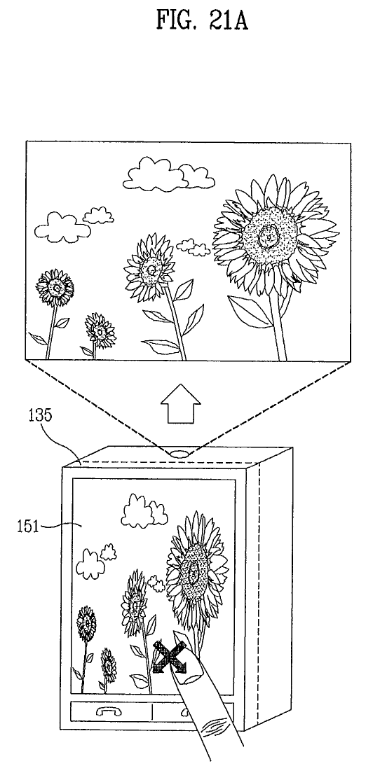

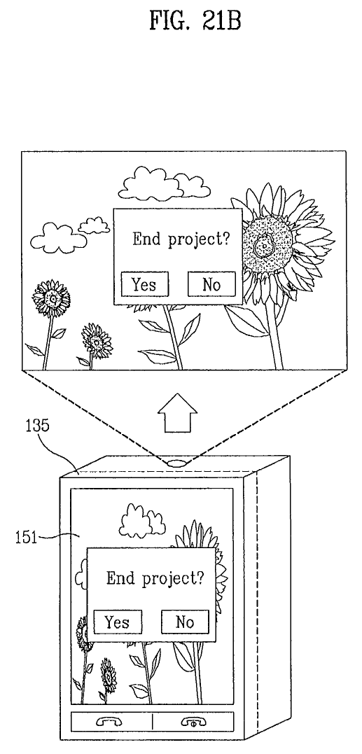

FIGS. 20A-21B are overviews illustrating other operations that can be performed based on a touch operation performed on the first image according to still another embodiment of the present invention. In this example, the touch action corresponds to a touch action specified per function to execute a function (e.g., an image shift, an image enlargement, an image block setting, an image identity display, etc.). Thus, because a touch action is specified to a function of an image shift, an image enlargement, an image block setting, an image identity display or the like and is stored, when a specific touch action to the touchscreen by a user is detected, the controller 180 can execute the function corresponding to the detected specific touch action.

For instance, the per-function touch can be specified in the following manner. First, a ‘touch-and-drag operation in the left direction’ can be specified to ‘shift to a pervious image’. Also, a ‘touch-and-drag operation in the right direction’ can be specified to ‘shift to a next image’, a ‘touch action for selecting a part to be enlarged (or boxed)’ can be specified to ‘enlarge an image partially (or to set a block), and a ‘touch action corresponding to end’ can be specified to ‘end project’. Thus, as shown in FIG. 20A, when an n^{th} image is displayed on an external surface, and if a touch-and-drag operation in right direction is detected, the controller 180 displays an (n+1)^{th} image on the external screen as shown in FIG. 20B. Further, in FIG. 21A, if a touch action for commanding ‘end projector’ is detected, the controller 180 displays a window for enabling a user to select ‘end projector’ on the external screen as shown in FIG. 21B.

Further, the above-described embodiments can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include transmission via Internet.

Accordingly, the present invention provides several advantages. First, because a projector module performing a projection function is provided to a mobile terminal, various types of information stored in the mobile terminal can be enlarged and displayed on an external surface. Secondly, as a touch to a touchscreen provided to a mobile terminal is detected, the image displayed on an external surface can be appropriately updated. Thirdly, as a touch pattern performed on a touchscreen provided to a mobile terminal is detected, a projected image can be enlarged, boxed, emphasized, provided with a menu display, or the like.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a touchscreen display unit configured to display at least a first image and to receive touch inputs;
a projector module configured to project the first image displayed on the touchscreen display unit as a second image on an external surface; and
a controller configured to detect a touch input on the touchscreen display unit, and to control the projector module to alter the displayed second image based on the detected touch input.

2. The mobile terminal of claim 1, wherein the controller is further configured to alter the second image by displaying an indicator on the second image corresponding to a same position touched on the first image displayed on the touchscreen display unit.

3. The mobile terminal of claim 1, wherein the controller is further configured to turn off the touchscreen display unit and only display the second image on the external surface based on a predetermined input operation performed on the mobile terminal.

4. The mobile terminal of claim 2, wherein the controller is further configured to shift the indicator displayed on the second image in correspondence with the detected touch input on the first image.

5. The mobile terminal of claim 1, wherein the controller is further configured to display an editing menu for editing the displayed second image on at least on the second image based on a predetermined input operation performed on the mobile terminal.

6. The mobile terminal of claim 1, wherein the controller is further configured to zoom in or zoom out the second image based on the detected touch input on the first image displayed on the touchscreen display unit.

7. The mobile terminal of claim 1, wherein the controller is further configured to highlight a portion of the second image based on the detected touch input on the first image displayed on the touchscreen display unit.

8. The mobile terminal of claim 7, wherein the controller is further configured to highlight the portion of the second image by drawing a shape around the portion of the second area based the detected touch input on the first image, and
wherein the detected touch input includes at least one of a touching and dragging operation from one point on the first image to a second point on the first image, and a multiple touching operation corresponding to a touching of the first and second points.

9. The mobile terminal of claim 7, wherein the controller is further configured to zoom in or zoom out the portion of the second image based on the detected touch input on the first image.

10. The mobile terminal of claim 1, wherein the controller is further configured to draw a line on the second image based the detected touch input on the first image displayed on the touchscreen display unit.

11. The mobile terminal of claim 1, wherein the controller is further configured to shift the second image based on the detected touch input on the first image displayed on the touchscreen display unit.

12. The mobile terminal of claim 1, wherein the controller is further configured to perform a predetermined operation on the second image based on the detected touch input on the first image displayed on the touchscreen display unit.

13. The mobile terminal of claim 1, wherein the detected touch input comprises at least one of a long touching operation, a multiple touching operation, a touch-and-drag operation, a touch-flicking operation and proximity touching operation.

14. A method of controlling a mobile terminal, the method comprising:
displaying at least a first image on a touchscreen display unit of the mobile terminal;
projecting the first image displayed on the touchscreen display as a second image on an external surface;
detecting a touch input on the touchscreen display unit; and
altering the displayed second image based on the detected touch input.

15. The method of claim 14, wherein the altering step alters the second image by displaying an indicator on the second image corresponding to a same position touched on the first image displayed on the touchscreen display unit.

16. The method of claim 14, further comprising:
turning off the touchscreen display unit and only displaying the second image on the external surface based on a predetermined input operation performed on the mobile terminal.

17. The method of claim 15, wherein the altering step shifts the indicator displayed on the second image in correspondence with the detected touch input on the first image.

18. The method of claim 14, further comprising:
displaying an editing menu for editing the displayed second image on at least on the second image based on a predetermined input operation performed on the mobile terminal.

19. The method of claim 14, wherein the altering step zooms in or zooms out the second image based on the detected touch input on the first image displayed on the touchscreen display unit.

20. The method of claim 14, wherein the altering step highlights a portion of the second image based on the detected touch input on the first image displayed on the touchscreen display unit.

21. The method of claim 20, wherein the altering step highlights the portion of the second image by drawing a shape around the portion of the second area based the detected touch input on the first image, and
wherein the detected touch input includes at least one of a touching and dragging operation from one point on the first image to a second point on the first image, and a multiple touching operation corresponding to a touching of the first and second points.

22. The method of claim 20, wherein the altering step zooms in or zooms out the portion of the second image based on the detected touch input on the first image.

23. The method of claim 14, wherein the altering step draws a line on the second image based the detected touch input on the first image displayed on the touchscreen display unit.

24. The method of claim 14, wherein the altering step shifts the second image based on the detected touch input on the first image displayed on the touchscreen display unit.

25. The method of claim 14, wherein the altering step performs a predetermined operation on the second image based on the detected touch input on the first image displayed on the touchscreen display unit.

26. The method of claim 14, wherein the detected touch input comprises at least one of a long touching operation, a multiple touching operation, a touch-and-drag operation, a touch-flicking operation and proximity touching operation.
